(19) United States
(12) Patent Application Publication
(10) Pub. No.: US 2004/0083170 A1
(43) Pub. Date: Apr. 29, 2004

(54) System and method of integrating loyalty/reward programs with payment identification systems

(76) Inventors: Ajay R. Bam, Belmont, MA (US); Robert J. Wesley, Wellesley, MA (US); Walter Stock, Newton, MA (US); Troy Chen, Jersey City, NJ (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 10/646,579

(22) Filed: Aug. 22, 2003

Related U.S. Application Data
(60) Provisional application No. 60/420,643, filed on Oct. 23, 2002.

(51) Int. Cl. G06F 17/60

(52) U.S. Cl. 705/40; 705/14; 705/39

(57) ABSTRACT

There is disclosed a system and method for coordinating a transaction by entering information pertaining to the transaction at a POS, the entered information being independent of identification of a recipient of the transaction. Independent from the entering of the transaction information there is established a communication connection from a device uniquely associated with the recipient to a location remote from the POS. The POS location is identified via the established communication connection; and the remote location coordinates the identified POS location with the entered information for the purpose of authorizing the transaction at the POS. In one embodiment any auxiliary entitlements, such as loyalty memberships, are identified and any available discounts are applied to the information entered at the POS. In one embodiment, the remote location authorizes payment of the transaction amount from third parties.

### PRIORITY

The present application claims priority from U.S. Provisional Patent Application No. 60/420,643, entitled “A PAYMENT SYSTEM INTEGRATING LOYALTY/REWARD PROGRAMS”, the disclosure of which is hereby incorporated herein by reference.

### TECHNICAL FIELD

This invention relates to point of sale (POS) identity systems and more particularly to systems and methods for allowing payment identity verification for goods or services while also coordinating such payment identity with reward, loyalty, marketing, promotion, and improved customer service programs.

### BACKGROUND OF THE INVENTION

As societies have become more and more mobile people have found it convenient, and usually mandatory, to carry on their person several items of critical importance. One of these items is a form of payment for goods and services and another of these items is a form of identity.

Before the concept of government sponsored currency came into vogue, people carried with them different forms of valuable commodities, such as gold, silver, diamonds. In some societies even beads were popular. With the advent of currency, coins, usually with a ruler's picture imprinted on one surface, were lugged around in sacks or purses. In every transaction the seller of goods or services needed to make sure of the authenticity of the payment. Usually this was based by verification of the validity of the payment by weighing or measuring, and often depended heavily upon the identification (and known or provable veracity) of the buyer.

Paper money issued by a reliable government solved many of the problems traditionally inherent with commercial transactions. Using such money, the identity of the payor is not critical so long as the authenticity of the currency is validated. For the past few decades this has again been changing, as credit cards, debit cards, stored value cards, and other forms of non-cash payment have taken hold. Concurrent with a change in payment method there has come an increase in the need for personal identification, both for the payment of goods and services and for the purpose of identification for other purposes. These other purposes include verification of group membership, such as entitlement to discounts, admission to museums, medical benefit entitlements, proof of car insurance, proof of valid licenses, and the like.

Thus the purse, or now more commonly the wallet, which at first served to lug around valuable and often heavy objects for bartering, now carries several forms of personal papers, usually in the form of plastic cards bearing magnetic identification strips. The wallet now carries different pieces of information and service provider information, such as identification cards, payment cards, loyalty cards, affinity cards, drivers licenses, coupons, and more. Key chains are also being used to carry tags containing these pieces of information.

Each of these cards enables specific services. For example, a credit card serves the function of providing the user credit for a purchase but does not serve the function of allowing the card to be used for debit purposes or for group identification, or for indicating that the holder has a valid license, or has valid insurance. Moreover, the information that is stored on these cards is permanent and cannot be changed at the will of either the issuer or the borrower. The wallet has again grown heavier as the number of identification cards has increased.

Compounding the problem, electronic devices, such as cellphones, PDAs, laptops, and the like, are now being carried by individuals, adding even further to the burden. The biggest drawback of a wallet is that the cards inside can be stolen and damaged by wear and tear. Thus, security of the cards is a big issue. Once stolen, the information printed on the cards can be used in a fraudulent manner or the information residing on the magnetic strip can be easily read and/or copied using a card reader. It takes time and cost (not to mention stress on the recipient) to re-acquire lost or stolen cards. Sometimes this information is fraudulently copied without the card owner even being aware resulting in losses to the card holder, the merchant, and/or the card issuer. While the lost or stolen card is being replaced, customers (and vendors) have lost opportunity costs of not being able to use the card. The cost of card replacement includes processing and mailing costs, and is thus not trivial.

Many stores also have their own affinity, loyalty or rewards programs, such as a Stop & Shop card, a CVS pharmacy card or a AAA card, which are programs operationally separate from the payment cards. This offers the additional inconvenience of needing to carry additional cards and swipe two different cards at a point of sale; one card for discount/rewards/identification, and one card for payment, and perhaps a third card just to enter the facility. Other stores have started to issue stored value cards for purchases, gifts, promotions, and returns. One use of such stored value cards occurs when a merchant records one or more transactions on a customer's card and then, after a certain number of transactions (or transaction amounts) have been entered, the customer is awarded a gift, or a discount, or some other item of value. In many respects these cards are being used to build customer loyalty and attract new customers.

Any use of physical cards requires an infrastructure to support its handling and processing. For example, most stores have a hardware device(s) that reads card, such as debit, credit or loyalty cards, and promotional coupons. These devices are commonly known as card readers (magnetic stripe readers, smart card readers, bar code readers, etc.) and each such reader requires software to manage it. One disadvantage of these systems is that they often require proprietary hardware. In all such systems there are ongoing system costs to keep the readers, the software and the back-office support up and running. Upgrade costs are also necessary from time to time. Often, a POS must have card readers (and the supporting software/hardware from several suppliers. One drawback to such a system is that new card providers cannot easily enter a market unless the new card company uses the already established networks and the card reading associated therewith.

There has recently been a rise of mobile phones and mobile devices as tools for commerce, communication, content and collaboration. These devices include mobile phones, pagers, radios, PDAs, electronic diaries and watches. As the use of such electronic devices has grown, so has the need to integrate the different devices for information and functionality. First developed in the 1970s, smart cards were introduced with the intention of having it serve as a programmable device to secure and carry encrypted data, such smart cards have seen only minimal success.

### BRIEF SUMMARY OF THE INVENTION

The present invention is directed to a system and method for coordinating a transaction by entering information pertaining to the transaction at a POS, the entered information being independent of identification of a recipient of the transaction. Independent from the entering of the transaction information there is established a communication connection from a device uniquely associated with the recipient to a location remote from the POS. The POS location is identified via the established communication connection; and the remote location coordinates the identified POS location with the entered information for the purpose of authorizing the transaction at the POS. In one embodiment any auxiliary entitlements, such as loyalty memberships, and marketing promotions are identified and any available discounts, premiums, or other extras are applied to the information entered at the POS. In one embodiment, the remote location authorizes payment of the transaction amount from third parties.

In one embodiment there is shown a system and method which uses a payment system or a payment platform in one embodiment consisting of a telephony system or mobile device that will dial, or connect through WIFI, GPRS or any other similar network connection into a web server or web portal on which is stored the customer's information and the merchant's information. The web portal is integrated both with existing clearing houses to clear electronic fund transfer transactions and with a loyalty/rewards and marketing promotions management system. In operation, the system handles payment transactions at the point of sale (POS) as well as handling the loyalty/rewards/promotions portion of the transaction. In one operation, the user receives the benefit of specials or other promotions all managed from the server. Other operations may require the user of the mobile device to input information which impacts the purchase transaction, such as gratuities, product/service selection/payment cards, loyalty programs, etc.

In another embodiment there is shown a system and method which uses payment, or a payment platform, consisting of a telephone system or mobile device that will dial or connect through various networks into a web portal on which is stored the customer's information and the merchant's information. The web server or web portal is integrated with one or more existing clearing houses to clear electronic find transfer transactions and also connected with loyalty/rewards and marketing promotions management system and possibly connect with other customer information systems (i.e., drivers license, medical records, insurance data, membership organizations). In operation, the system transmits payment information to the POS based upon the operator's input on the mobile device. The POS in this case could be at the store or some virtual location. Examples of this application include ordering and paying at a restaurant, paying for parking, ordering and paying for tickets at an entertainment location, sending identification information to a known POS.

In another embodiment of the system, the enrollment of payment information includes the mobile device dialing into a designated phone number which will read the information from the mobile device and allow the customer to enter additional information required. Another embodiment allows the user to enter information at the merchant's POS and automatically links that information to the customer.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is the overview of one embodiment of a payment/loyalty architecture;

FIG. 2 describes an embodiment showing a payment scenario in accordance FIG. 1;

FIG. 3 is a flow chart showing one embodiment of the scenario of FIG. 2;

FIG. 4 is a flow chart showing one embodiment of enrolling a person for a mobile account by sending that person a mobile gift;

FIG. 5 is a flow chart showing one embodiment of enrolling a person for a mobile account from a merchant's location; and

FIG. 6 shows another embodiment of the scenario of FIG. 2.

### DETAILED DESCRIPTION

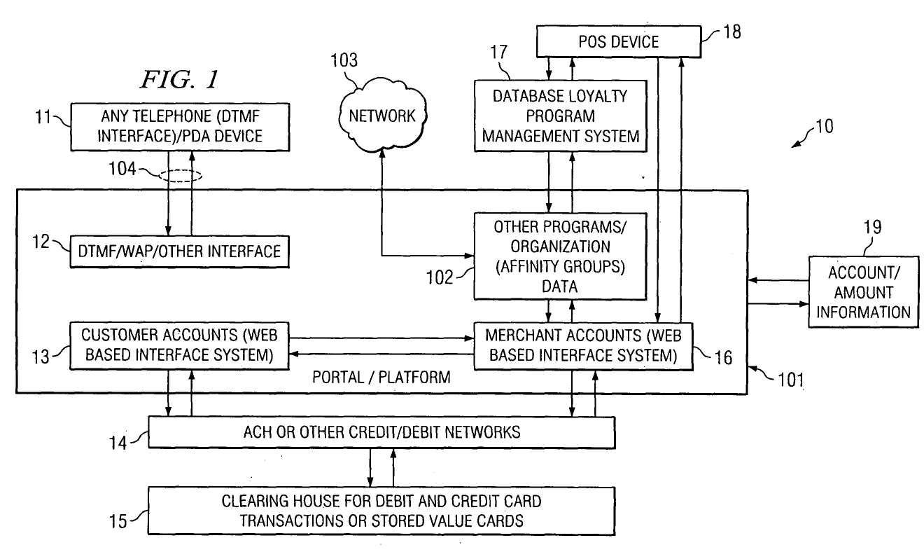

Payment system 10, shown in FIG. 1, offers consolidation, convenience and management of all of a user's cards at one place through a website and further enables the use of these electronic/physical cards, coupons, and other promotional information at a physical or virtual location using a phone. The customer's phone, such as phone 11, may be wired or wireless and may operate through dial up or via GPRS and/or WIFI networks. While a telephone is shown, the device can be a PDA, computer, pager, or any other communication device. A person may register his/her new or existing payment and loyalty cards/accounts, such as checking or savings accounts, debit, credit or loyalty cards with the web portal at any POS or by calling a designated telephone number. Once the user connects with the portal, the user selects which card (or cards) he/she desires, which loyalty programs he/she is eligible for, and/or which stored value cards the user desires to link to his/her mobile payment account. Different cards and programs may be used in different stores, if desired.

Assuming a merchant (enterprise) has enabled system 10 to handle payments (or identification) any of that merchant's POS locations 18 can be used by a prospective recipient of goods/services. In one embodiment, the merchant can go on line and sign up and also each recipient, or prospective recipient, can go on-line (or otherwise sign up). In doing so, the recipient user goes to the web portal, signs up for payment methods and loyalty cards, and registers his/her existing payments and loyalty cards. The user can sign up for new cards at this or anytime, if so desired. All of the customer's and merchant's specific data will be stored in a secure form on the respective database 13, 16. As will be seen, when a user uses the system, if that user is enrolled in a loyalty program, then it automatically arranges for the appropriate discounts before charging the customer.

The benefit of system 10 to the issuer of the cards/merchants/banks is quick and electronic access to the customer, better customer relationship management, including more effective and personalized communication, tracking of customer behavior, and customer needs. Also, the system facilitates the use of payment cards and loyalty programs within minutes after being issued. Fraud is further reduced in the entire system as compared to the traditional credit card charges since there is no piece of paper giving away the credit card number. This could translate into reduction in transaction fees for payments, such as credit, debit or ACH. Additionally, logging of transactions/receipts in a web portal or email system saves paper and printing costs to retailers.

To the end consumer (recipient), the system offers convenience, consolidation of cards, management of expense at the point of sale, availability of cards in electronic form, easy sign up for new cards, digital receipt management, a web interface and consolidation of reward programs. The system allows a consumer to complete a payment transaction using existing payments methods such as checking, Account Clearing House (ACH) services used mainly for electronic fund transfer through direct deposits or direct payments, debit and/or credit cards. In addition, the system allows the consumer to use all of his or her cards/accounts in electronic form at a point of sale location using a telephone (wired or wireless) for payments, loyalty programs and for identity, and will allow from the integration of different cards/programs.

Continuing in FIG. 1, system 10 controls the operational aspects of the concepts discussed. The user may use any communicating device 11, such as a telephone, PDA, etc, to communicate with portal/platform 101. Note that the communication can be wireline or wireless and in the embodiment shown would be based on the well-known dual tone multi-frequency (DTMF) standard. In the future, DTMF may be enhanced or replaced by a wireless application protocol (WAP) client or Bluetooth technology or any other technology for enabling the transactions to occur. Initially, interface unit 12 will use a telephony application program interface (TA-PI) which will allow platform 101 to detect the DTMF digits. Platform 101 can be a single portal or multiple portals, either on a single server or on multiple servers. This server(s) can be any processor based system having access to application programs for control purposes, database(s) for storage and one or more communication networks 103, 104.

Platform 101 may use one or more types of security levels to identify a consumer, such as equipment ID, caller ID, and/or a unique pin number, or other types of encryption and authentication methods. If the user were using a wireless telephone, standards in the United States associate one telephone number with one mobile phone, thereby allowing interface (database) 13 to properly identify the calling user. If the user is calling from a wire-line telephone, calling party ID could be used to identify the caller. In the future, other secure ID methods, such as biometrics, voice recognition or other secure methods may be used, under control of interfaces 12 and 13, or an added security module.

Retailer database 17, which controls transactions and loyalty program platforms, unique to particular enterprises uses, for example, XML or similar technologies along with one of the many currently available API's (Application Program Interfaces) so that the platform can communicate to any POS device 18 used by an enterprise. Platform 101 provides interface 13 for use by recipient end-users (customers of a merchant) and interface 16 where merchants can assess and manage their accounts. Interfaces 13 and 16 could be web based, if desired, for easier management by users and/or enterprises.

Platform 101 may incorporate security technologies, such as PKI (public key infrastructure) software for encryption and user certificates. PKI enables users to securely and privately exchange data, including data representing money, through the use of a public and a private cryptographic key pair that is obtained and shared through a trusted authority. PKI is the preferred approach for digital security, but any transaction protocol can be used.

Transactions incoming to platform 101 will filter through network 14 or through network 15 checking ACH, ATM, debit or credit card, or may filter through other transaction clearing houses, such as affinity groups, stored value cards, etc. Depending on the type of transaction, the payment data will be routed to the appropriate processing entities. An ACH is a secure electronic fund transfer system that connects all U.S. financial institutions and acts as the central clearing facility for all Electronic Fund Transfer (EFT) transactions that occur nationwide. ATM/debit and credit card transactions will be sent to the appropriate banks, or clearing agency, for approval and clearing. These will be done through different ATM/debit or credit networks, such as Cirrus, NYCE, Maestro, Visanet, etc. The customer standing in proximity to the POS terminal, as will be discussed, decides on which form and which third party payment he/she desires. Platform 101, in cooperation with account information database 19, and networks 14 and 15, all together acting as a server, then controls the transaction to satisfy the merchant that the merchant will be paid for the goods and services, less any discount applicable. Note that a user may decide to have a part of the transaction on one credit card and a part on a second (or third) credit card or a debit card or on a stored value account.

Platform 101 communicates with merchant transaction database (part of merchant accounts system 16) and with merchant loyalty system 17. This is accomplished through an API (Application Program Interface) that communicates among all the necessary databases and with POS device 18. This design allows for a software only integration. A key (keyboard or touch screen or similar) at POS system 18 (not shown) may be designated for different transactions, such as returns and/or identification.

Platform 101 allows a consumer at a retail point of sale location, such as 18, to access his/her individual checking (ACH)/debit/credit/loyalty/stored value account(s) through their cell (or other) phone and make a payment. During the process, the consumer will also automatically access loyalty programs, for example, those stored in platform 17 or otherwise associated with the location at which that consumer is located. The consumer will receive any eligible discounts. These discounts can be provided by the merchant, the manufacturer of goods or services, the company running platform 101, or even the bank or credit/debit company, or via a membership organization as controlled by database 102 and network 103 that the purchaser belongs to. These affinity programs can be stored in separate databases, or in a common database and can be local to platform 101 or remote therefrom.

One example of such use would be with loyalty systems, such as when a customer shops at a store and for each dollar spent the customer earns credit for a purchase of a product at another location. Thus, if a customer were to buy, say, twenty dollars worth of groceries, the customer would receive a two cents a gallon discount on gasoline bought from a gas pump located outside. The system would keep track of such grocery purchases and would automatically discount the gasoline purchase. Note that this can work in the opposite direction, such that the customer can buy the gasoline before shopping for groceries and then when the customer goes to the POS for the groceries and then when the customer goes to the POS for the groceries and pays for his/her purchases via the system described herein, the prior gasoline purchase would be credited with the now available discount. Also, a person might be entitled to a discount at many locations depending upon that person's membership in an organization, such as, (for example, the AARP or AAA). Thus, if a person were entitled to say a 10% discount at certain parking facilities, that discount would be applied under control of the system without the person even requesting it.

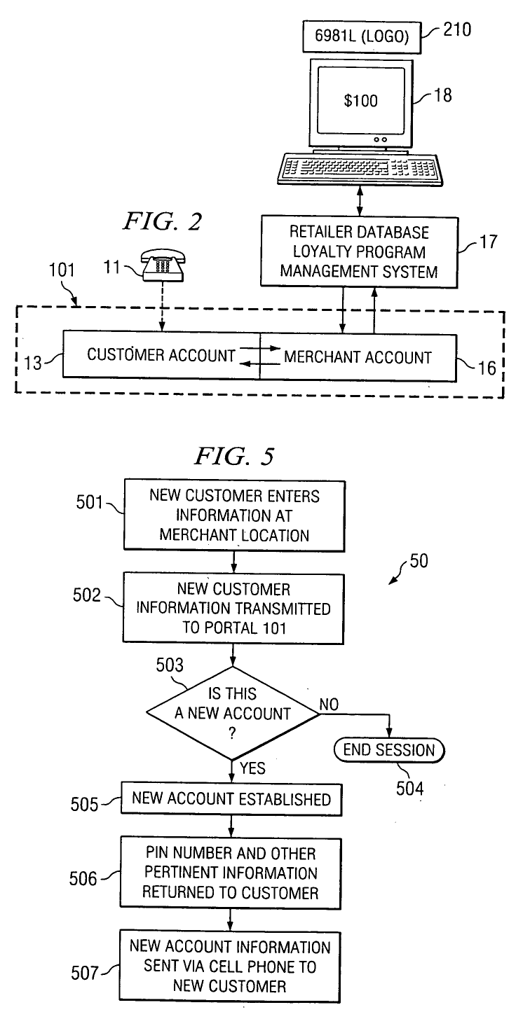

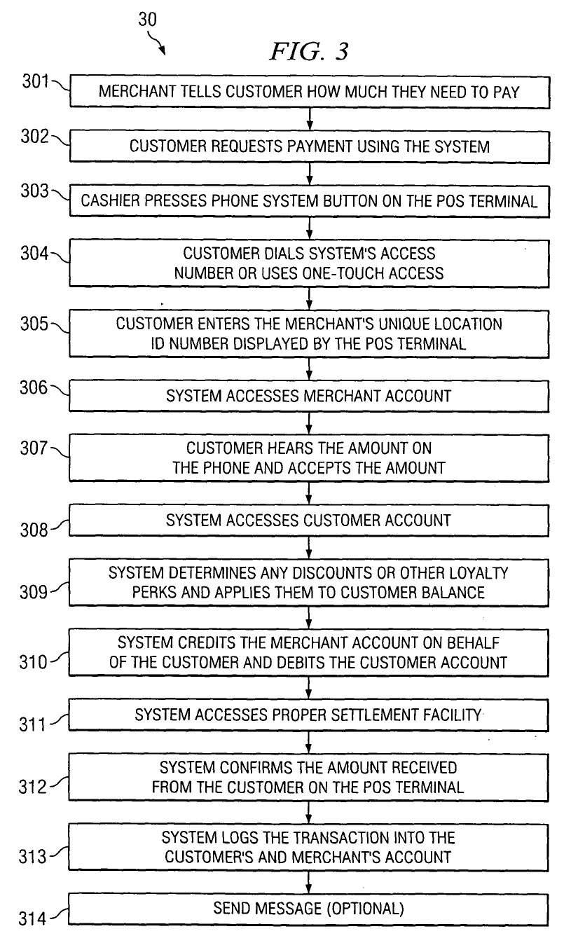

In operation, as shown, in FIGS. 2 and 3, the consumer approaches POS terminal 18 at a merchant whose point of sale is enabled to work with platform 101, or a similar platform. In the case of license verification, the inquiring person would approach the person to be verified. The clerk (or inquiring person) rings the consumer's merchandise into the POS as in any other transaction and will then ask (process 301, FIG. 2) the consumer how the customer would like to pay, “Cash, Charge, or Phone System”, (process 30, FIG. 3). The consumer who has already signed up for a phone system account, answers “phone system” (process 302). At this point the clerk presses the phone system payment key on the register (process 303), and waits for confirmation. The clerk could, instead of pushing a key on the register, otherwise actuate a connection from the POS to portal 101, FIG. 1.

In the case of an identity check, the requesting person enters the information desired to be verified into the system under the control of the inquiring person.

While the clerk is ringing up the order (or the requester is entering the data), the consumer dials (or speed dials) the phone system server which is part of interface 12 (FIG. 1) (process 304, FIG. 3). The customer then enters a unique POS identification number that is displayed, with the phone system logo, if desired, on the cash register (process 305, FIG. 3 and element 210, FIG. 2). This POS location number can be displayed on the terminal, displayed on a sign posted at the POS location, or printed on a POS tape, or restaurant tab, or it can be an officer's badge number, a number printed on a vendor's hat or shirt, or any other unique number associated with the POS, such as a parking meter or vending machine number. Another option allows the location number to be integrated into a unique phone number for that particular merchant. In that case the customer needs to only dial the unique telephone number of the POS to interface with the merchant POS.

The consumer then hears (or views) through his/her cell phone a request for payment (or verification) from the merchant's system together with the original amount and any appropriate rewards/discounts that pertain to that user. This is controlled via processes 306, 307, 308, 309. For certain, applications the consumer may be requested to add data, such as a gratuity, or the customer may select a different payment and/or loyalty option. The customer may select which form of payment (which third party payor, Visa™, MasterCard™, etc.) he/she desires for this transaction. Note that the consumer may want part on one account and part on another account. The consumer then verifies the payment by entering his/her personal identification number (PIN), if desired, or press a key (i.e., 1 or #) to indicate approval. The PIN number could be sent using DTMF or other signals and the PIN number may be generated by biometrics (finger print, voice print, etc.). Note that the need to enter the PIN or approving the transaction by entering a key may be optional and may vary depending on the dollar amount or type of merchant etc. Approval may simply happen by dialing the POS terminal and entering location number. Interface 12 controls the provision of voice, or data (or both) to the customer's phone using, for example, interactive voice response equipment, or the like.

Note that the steps of dialing and entering the location ID may be merged together. Such merger would result in a unique telephone number being posted on the POS terminal that a consumer might dial to indicate the function of payment and location. Thus, by dialing a unique telephone number on the consumer's device allows the system to recognize the location where the payment is to be sent and also serves as a number to connect to platform 101. Note also that the merchant need not ever be made aware of which form of payment the customer has chosen to use, thereby further reducing opportunities for fraud and bad behavior.

After the consumer has verified payment, the system, using links to the national clearing houses 14, arranges for payment 310, 311 and the clerk receives visual notification 312 through the POS system that the payment has been made. When identity is the issue, a picture of the user could be sent to the requester, either via the requester's system or most likely, via a display on the user's terminal. At the entrance to a sporting event or theatre, a copy of the ticket could be displayed on the customer's screen. A receipt of the transaction can be sent to the consumer's e-mail address or a SMS message can be sent to the consumer's cell phone, verifying the transaction, under control of customer database 13.

It is, of course, possible to combine processes 304 and 305 (and perhaps other processes as well). This could be accomplished, for example, by posting a unique telephone number on the POS terminal. The consumer could dial that number to indicate acceptance of payment information coming from that location. Thus, dialing a unique telephone number would allow the system to recognize the location where the payment is to be sent and would also serve as a number to connect to the telephone payment system and for coordinating all programs for the user.

It should be noted that while a commercial transaction, as discussed in the embodiment described herein, is initiated by a clerk at a traditional POS cash register, the concepts of the invention are not so limited. For example, the customer may perform self-checkout (by scanning the bar codes on his/her purchases, or otherwise) or the customer may be using a card (or license) for self identity or entitlement purposes without actually purchasing merchandise. Such identity could be, for example, verifying the physical identity of the person, or showing that the person has a valid license (such as, for example, a driver's license, a fishing or hunting license, a pilot's license, or the like) or a valid insurance card (vehicle, medical, or otherwise), or identifying the person as holding an entitlement card (such as a zoo membership or an alcoholic beverage consumption permit), or showing that the person is entitled to admission to an event (such as a movie, sporting event, or the like). The person may elect to send funds, admission evidence, and/or loyalty points in a commercial or non-commercial transaction to another person utilizing the same platform. Such transfer would be passed to the other person's account via SMS and/or IVR and possible also to a website using email. In some situations, the transferred information could be sent to the other person's mobile device (cell phone).

In each of these situations, the recipient of the commercial transaction need only become in communication contact with a proper central control point using a temporarily established connection and enter the specific location identity where the transaction is occurring, via that temporary connection. The person in charge at that location (user, gate attendant, waiter, police officer, medical personnel) (who is using his/her own established communication connection) then would be notified that the person who placed the connection is authorized to proceed with whatever commercial transaction is occurring. The notification to the person in charge can be via the recipient's communication device, but most likely will be by a separate communication directly to the person in charge or to a terminal in proximity to such person in charge.

Also note that the term commercial transaction is not limited to situations where money changes hands but extends to all situations where a recipient (or prospective recipient) of services or goods of any nature is involved, or where the purpose is to identify the recipient, either as to physical identity or as to entitlement for a specific purpose. Thus, the term POS is used herein to mean any location where any such identification and/or authorization is granted.

The identity of the POS terminal could be a badge number of the person requiring the verification of identity, or it could be the gate number of an arena to which the person desires entry, or a cell phone number, or an identification number of a gasoline pump, or it could be any other information uniquely identifying the location or identity of the person, (for example, a unique number or code printed on a receipt) requiring identity verification and/or payment. In some situations, GPS coordinates would work and in other situations the latitude/longitude of the location, or street corner crossing, or mileposts along a highway, would also suffice. All that is needed is a unique correlation between the source of the inquiry and the location of the user, so that the system can correlate the two for verification purposes. This then allows information coming from a merchant (or other person requiring identity verification) to be validated over a separate connection originating from the person being verified. Under this system, the merchant does not gain access to the customer's payment account number (credit card number), thereby further securing such number.

As used in the specification and claims, a POS device need only be capable of confirming that a financial transaction has occurred. It can be a credit card terminal like those manufactured by Verifone® or Hypercom®, or it could be a standard retail POS, such as those manufactured by IBM, NCR, etc., or it could be a PC, vending machine or Kiosk, or a handheld PDA, cell phone or electronic printer, or it could be any other device which is capable of capturing data. A POS could be a virtual database which also could be accessed by other devices, such as a wireless handheld, or a wired PC. A POS device must be able to receive confirmation of a transaction, but need not send or input purchase data.

A POS location may be a person, a transaction number identified on a receipt, a device, a web account, or a physical or virtual space having a unique identity assigned to an entity. The POS location has a unique identification associated with the POS.

A merchant may be a party giving or receiving payment for rendering services as in a store, cafe', or it may be a device such as a parking meter or vending machine or it may be another person who is due a legal tender for a service or goods offered.

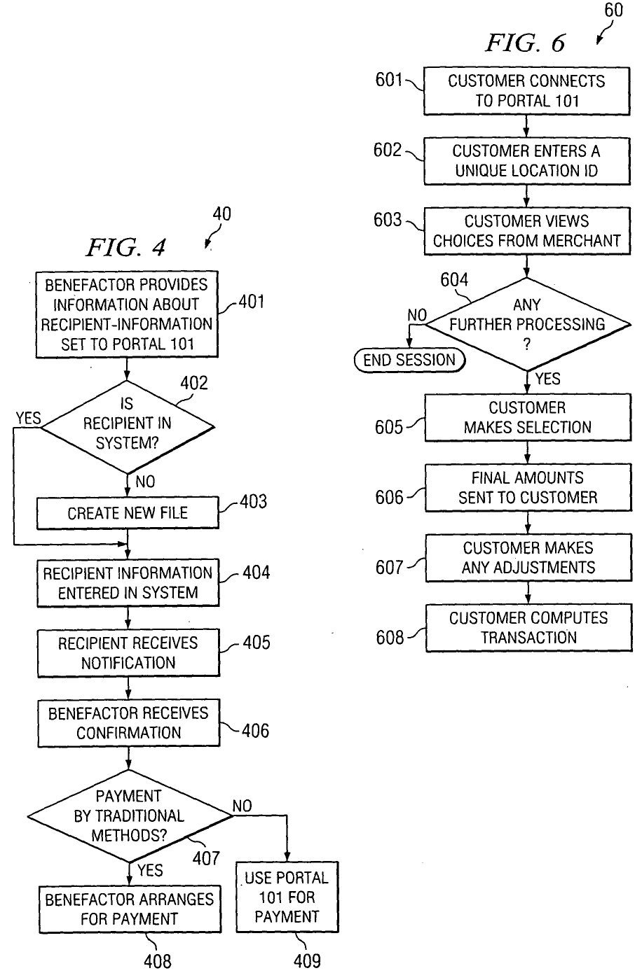

FIG. 4 illustrates one embodiment 40 of how one person (benefactor) can enroll another person (recipient) for a mobile account by arranging for a mobile gift at a POS. In process 401 the benefactor provides the merchant with the recipient's cell phone number and the amount of the gift. This can be accomplished verbally or electronically and can be done in person or via a communication link. While the embodiment discusses POS gift enrollment, the same procedure could be followed by having the benefactor log on to a web site of either the merchant or the operator of the system discussed herein. If a POS terminal is being used then the merchant enters the received information into the POS terminal. A special greeting, such as Merry Christmas, Happy Birthday, etc. can also be added. This information is communicated to portal 101 (FIG. 1) for processing.

Portal 101 then checks, via process 402 to see if the recipient is already registered in the system or if a new account is to be set up for the benefactor. If the recipient is not in the system then process 403 creates a new file for the recipient and enters the information pertaining to the recipient in the proper data bases via process 404. If the recipient is an existing member then the information is entered in one or more of its data bases, via process 404. Note that if the recipient already had an account, the benefactor need only provide some identification at the POS and need not actually know the cell phone number since that can be provided by portal 101.

In process 405 portal 101 sends a communication to the benefactor via the benefactor's cell phone (or email, if available). Any special greeting, such as Happy Birthday is then transmitted to the benefactor. At this time, the benefactor receives his/her PIN number if not already known to him/her.

Process 406 controls the acknowledgement/confirmation to the benefactor indicating that the gift has been sent. This acknowledgement could, for example, be a text message, or it could be in the form of gift card that the benefactor could then print and send to the recipient.

Process 407 controls the payment of the gift card by the benefactor. If the payment is to be by traditional methods, such as cash, credit, debit or stored value card then process 408 controls payment in the well-known manner. If the benefactor desires to use portal 101 then process 30, FIG. 3, is followed.

FIG. 5 illustrates one embodiment 50 illustrating the enrolment of a customer at a merchant location. In process 501, a customer who desires to be enrolled in the system can go to any POS terminal at a merchant location and enter his/her cell phone number and payment method, such as credit card(s), debit card(s), stored value card(s) and any loyalty and other affinity groups.

In process 502 this information is transmitted to the central system, such as to portal 101 (FIG. 1) via a connection from the merchant's POS. This connection can be a dedicated connection or a temporary connection and can be wireless or wireline and can be over the telephone network or a data network.

Process 503 at portal 101 checks to see if this is indeed a new customer. This check can be made by matching cell phone or other information, such as credit/debit card information. If the information matches an existing account then the session ends via

process 504. If the information is for a new customer then process 505 controls the establishment of a new account.

Process 506 then provides the PIN number and any other information, for example, system operation information, to the new customer via the POS terminal. At the same time, or after a delay, this same information can be sent to the new customer's cell phone and/or to an email address provided by the new customer. The new customer can also be given access to portal 101 to view his/her account on-line, if desired. The message to the cell phone can be verbal and/or text and can be sent via SMS or otherwise.

FIG. 6 illustrates system 60 which is another embodiment of the scenario of FIG. 2 in which a customer desires to obtain a product or service from a merchant, or desires to provide the merchant (police officer, ticket taker, etc) with identification.

In process 601 the customer connects to system 10 via portal 101 by dialing, or otherwise establishing a temporary connection from the customer's phone or other electronic device, such as a PC, PDA or the like. This connection could be WIFI, GPRS, wireline, etc. This information could be input by keypad or voice activated.

In process 602 the customer enters a unique ID of a location, such as a parking meter number, a vending machine number, a catalog number, a badge number, a GPS location, a cross-street, etc. In some cases this will be enough to identify the provider of the goods or services and in some cases more information will be required. Portal 101 could ask for such additional information, which would then be provided. Some of this information could, for example, be biometric, such as the user's voiceprint (fingerprint, etc.) or the merchant's voiceprint (fingerprint, etc).

Portal 101 then, either from its own data bases, or in cooperation with the merchant's data bases, provides, via process 603, the customer with choices to select from. In the case of a parking meter, the time charges would appear. If the customer had called a merchant with a catalog, pages of information, perhaps with pictures, would be provided. If the customer were trying to get into a sports event, or trying to prove his/her identity to a police officer, his/her sport ticket (or driver's license) would be displayed on the customer's cell phone.

In situations where the system is being used to show identity, or membership in an organization (zoo, museum, etc) no further action is required, as determined by process 604.

In process 605 the customer makes his/her selection and in process 606 the amount is sent to the customer and in process 607 the customer makes whatever adjustments are necessary (as discussed above with respect to FIG. 3) and enters his/her acceptance. In process 608 the customer transaction is complete.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system for coordinating transactions, said system comprising:
a server for accepting over a temporarily established communication connection from anyone of a plurality of users information specific to one of many merchants, said information including data specific to a unique POS location of one of said merchants;
means for coordinating said received information from a specific one of said users with information available to said server pertaining to said unique merchant location; and
means for communicating at least a portion of said coordinated information to said one user over said temporarily established connection.

2. The system of claim 1 wherein said information to said one user comprises:
cost information pertaining to said information obtained from said specific location.

3. The system of claim 2 further comprising:
means at said several for accepting further information from said one user, said further information comprising acceptance information.

4. The system of claim 3 further comprising:
means at said server for coordinating payment to said one merchant from said one user, said payment based upon said information communicated to said user and said acceptance information from said user.

5. A method for coordinating transactions, said method comprising:
accepting over a temporarily established communication connection from anyone of a plurality of users information specific to one of many merchants, said information including data specific to a unique location of one of said merchants, said specific data pertaining to merchandise obtained from said merchant;
coordinating said received information from a specific one of said users with available information pertaining to said unique merchant location; and
communicating at least a portion of said coordinated information to said one user over said temporarily established connection.

6. The method of claim 5 wherein said information to said one user comprises:
cost information pertaining to said information obtained from said specific location.

7. The method of claim 6 further comprising:
accepting further information from said one user, said further information comprising acceptance information.

8. The method of claim 7 further comprising:
coordinating payment to said one merchant from said one user, said payment based upon said information communicated to said user and said acceptance information from said user.

9. The method of coordinating the purchases from a merchant to a customer, said method comprising:
establishing, under control of said customer at a POS terminal when purchase information is entered by said merchant at said POS terminal, a temporary communication connection to a server independent from said merchant for coordinating preestablished payment options with respect to said purchase information; and
under control of said server and upon receipt of the location ID of said POS terminal and other information entered by said customer, providing to said merchant sufficient information to satisfy said merchant that said customer has arranged proper payment for said purchase.

10. The method of claim 9 wherein said payment sufficient information includes any payment reductions available under any affinity programs available to said customer.

11. A method for coordinating a transaction, said method comprising:
at a point of sale (POS) associated with said transaction, entering information pertaining to said transaction, said information being independent of identification of a recipient of said transaction;
establishing a temporary communication connection from a device uniquely associated with said recipient to a location remote from said point of sale (POS);
identifying said point of sale (POS) location via said device and an established communication connection; and
coordinating said identified point of sale (POS) location with said entered information.

12. The method of claim 11 wherein said coordinating comprises:
verifying the identity of said recipient.

13. The method of claim 12 wherein said identity is at least one of those selected from the list of: identity of said recipient; verification that said recipient is a member of a particular group; verification that said recipient is entitled to a particular service; verification that said recipient is entitled entry to a particular event; verification that said recipient holds a valid license; or verification of payment information.

14. The method of claim 11 further comprising:
verifying under control of said remote location the acceptance by said recipient of said coordinated information.

15. The method of claim 14 wherein said verifying includes receipt of specific data from said recipient over an established communication connection.

16. The method of claim 11 wherein said POS is associated with an enterprise, said method further comprising:
authorizing, under at least partial control of said remote location, payment by a third party to said enterprise associated with said POS, the amount of said payment identified by said entered information.

17. The method of claim 16 further comprising:
identifying any said authorization with other programs pertaining to said recipient and said POS.

18. The method of claim 17 wherein said other programs are selected from the list comprising:
loyalty, discount, coupons, points, licensing, organization membership.

19. The method of claim 17 further comprising:
deducting from said payment amount any amount said recipient is entitled to under said identified other programs.

20. The method of claim 11 further comprising:
communicating said entered information to said remote location over a communication path separate from said temporary established communication path.

21. The method of claim 11 further comprising:
associating any said coordination with any other programs pertaining to said recipient and said POS.

22. A system for facilitating identification of a user, said system comprising:
a point of sale (POS) terminal for entering and/or receiving information, said information separate from any personal information of said user;
a database remote from said point of sale (POS) terminal;
means for establishing a communication connection between said user and said database, said communication connection separate from the communication connection over which said point of sale (POS) information is entered; and
means, including communicating the identity of said point of sale (POS) terminal to said database via said established communication connection, for allowing said database to coordinate said user to information entered at said point of sale (POS).

23. The system of claim 22 wherein said last mentioned means comprises:
means for further coordinating said user with at least one affinity group associated with both said user and said POS terminal.

24. The system of claim 22 wherein said system further comprises:
means for communicating the identity of said user to said POS.

25. The system of claim 22 wherein said system further comprises:
means for communicating the identity of said user to a third party for payment to said POS in accordance with the information entered at said POS.

26. The system of claim 25 wherein said identity communicating means comprises:
said communication establishing means.

27. The system of claim 25 wherein said identity communication means comprises a communication path separate from said communication connection establishing means.

28. The system of claim 25 wherein said information entered at said POS is communicated to a location remote from said POS.

29. The system of claim 28 wherein said entered information at said remote location and said database are in communication with each other.

30. The system of claim 25 further comprising:
means for further coordinating said user with at least one group associated with both said user and said POS terminal.

31. The system of claim 30 wherein at least one of said groups associated with both said user and said POS is a loyalty program, said system further comprising:
means for deducting from said payment any amounts discounted to said user based upon said loyalty program.

32. The system of claim 30 wherein at least one of said groups associated with both said user and said POS is an affinity program, said system further comprising:
means for communicating said entered information from said POS to said loyalty program.

33. The system of claim 22 wherein said communication connection establishing means includes a telephone.

34. The system of claim 22 wherein said telephone is wireless.

35. The system of claim 22 wherein said last mentioned means comprises:
includes the communication of user specific data over said established connection to said database.

36. The system of claim 25 wherein said user specific data is transmitted via a telephone.

37. A method for authorizing payment for purchases made by a user, said method comprising:
entering information pertaining to said purchases at a point of sale (POS) terminal;
communicating over a temporarily established communication connection information unique to said user, said information including the identity of said point of sale (POS) terminal; and
comparing said information obtained over said temporarily established connection with stored information pertaining to said user and with said entered purchase information.

38. The method of claim 37 further comprising:
authorizing payment for said purchases based, at least in part, on said comparing.

39. The method of claim 38 wherein said payment is by at least one third party.

40. The method of claim 38 further comprising:
under control of said comparing, determining any special treatment due to said user based, at least in part, on said purchase information.

41. The method of claim 40 wherein said authorizing step includes deducting any amounts from said authorized payment due to any said determined special treatment.

42. A system for controlling transactions involving users, said system comprising:
a terminal for sending to a control center information pertaining to a particular transaction for a specific user;
a device for establishing a temporary communication connection from said specific user to said control center; and
a control system at said control center for matching information received from said user pertaining to the identity of said terminal with the actual information received from said terminal.

43. The system of claim 42 wherein said control system further comprises:
means for determining any affiliation said user has pertaining to said terminal.

44. The system of claim 43 wherein said control system further comprises:
means for controlling said transaction in accordance with said determined affiliations; said controlled transaction being at least one of the transactions selected from the list of: third party payment; loyalty discounts; identity of the user; authorization to enter a facility; verification of a license; and verification of a group affiliation.

45. The system of claim 44 wherein said device comprises:
a telephone, PDA, computer, pager.

46. The system of claim 42 wherein said device is one selected from the list of telephone, PDA, computer, pager.

47. A system for coordinating a transaction, said system comprising:
a first device for delivering POS information to said system, said information pertaining to said transaction; and
a second device for establishing a temporary communication connection from said second device to said system.

48. The system of claim 47 wherein said information necessary to further process said transaction comprises:
payment validation.

49. Th system of claim 48 wherein said payment validation comprises:
discounts unique to said second device.

50. The system of claim 47 further comprising:
means for coordinating information from said first and second devices with information from other sources.

51. The system of claim 47 wherein said coordinating means comprises:
means for storing certain of said information from said first device and certain of said information from said second device in at least one database on a transaction by transaction basis for subsequent use in other transactions involving said second device.

52. A method of providing gift credit from a benefactor to a recipient, said method comprising:
providing, under control of said benefactor, a telephone number of said recipient;
providing, under control of said benefactor, an amount to be credit to said recipient; and
communicating to said recipient via said provided telephone number that said recipient has a credit in the amount provided by said benefactor.

53. The method of claim 52 further comprising:
allowing said recipient to make purchases using said credit provided by said benefactor, said allowing comprising:
at a POS when said purchase information is entered allowing said recipient to use said telephone to establish a communication connection for coordinating said credit with said purchase information.

54. The method of claim 52 wherein said allowing further comprises:
from said recipients telephone providing the location ID of said POS.

55. A method for enrolling a customer in a wireless transaction payment program;
said method comprising:
entering, at a POS terminal, information identifying a wireless device of a customer;
further entering at said POS information pertaining to credit/debit/stored value cards/cash/ACH desired to be used by said customer in conjunction with said identified wireless device; and
allowing said customer to make purchases at one or more POS locations under control of a temporary communication connection established at a POS from said identified wireless device, said communication allowing said customer to transmit a location ID of said POS as well as other acceptance information to satisfy a merchant that said merchant will be paid for said purchase.

56. The method of claim 55 further comprising:
allowing said customer to instantly become enrolled in said merchant's programs.
